(19) United States
(12) Patent Application Publication
(10) Pub. No.: US 2019/0272846 A1
(43) Pub. Date: Sep. 5, 2019

(54) SMART ROBOT AND METHOD FOR MAN-MACHINE INTERACTION

(71) Applicants: Fu Tai Hua Industry (Shenzhen) Co., Ltd., Shenzhen (CN); Hon Hai Precision Industry Co., Ltd., New Taipei (TW)

(72) Inventors: XUE-QIN ZHANG, Shenzhen (CN); NENG-DE XIANG, Shenzhen (CN)

(21) Appl. No.: 15/959,370

(22) Filed: Apr. 23, 2018

(30) Foreign Application Priority Data
Mar. 1, 2018 (CN) 201810170642.4

(51) Int. Cl. G10L 25/63; G10L 15/02; G06K 9/00; B25J 11/00; B25J 9/00

(52) U.S. Cl. CPC G10L 25/63; G10L 15/02; B25J 9/0003; B25J 11/0005; G06K 9/00281

(57) ABSTRACT

A method for man-machine interaction applied to a smart robot with a man-machine interaction system acquires voice data/information of user by a voice acquiring unit, and recognizes the words of the acquired voice to determine user's emotional characteristic. The user's intention is determined according to the words used, and a response according to the user's emotional characteristic, the user's intention, and a response relationship table is determined upon. A relationship between a number of user's emotional characteristics, a number of user's intentions, and a number of responses is stored in the system. A voice outputting unit of the system is controlled to output the determined response which can include a simulated expression or animated image displayed on a display of the smart robot system.

### CROSS-REFERENCE TO RELATED APPLICATIONS

This application claims priority to Chinese Patent Application No. 201810170642.4 filed on Mar. 1, 2018, the contents of which are incorporated by reference herein.

### FIELD

The subject matter herein relates to robotics.

### BACKGROUND

With the development of artificial intelligence, making a robot understand human's emotion and interface with the human can be problematic.

### BRIEF DESCRIPTION OF THE DRAWINGS

Implementations of the present disclosure will now be described, by way of example only, with reference to the attached figures.

FIG. 1 is a block diagram of one embodiment of a running environment of a man-machine interaction system.

FIG. 2 is a block diagram of one embodiment of a smart robot.

FIG. 3 is a block diagram of the man-machine interaction system of FIG. 1.

FIG. 4 is a schematic diagram of one embodiment of a response relationship table in the system of FIG. 1.

FIG. 5 is a schematic diagram of one embodiment of an expression relationship table in the system of FIG. 1.

FIG. 6 is a flowchart of one embodiment of a man-machine interaction method.

FIG. 7 is a flowchart of one embodiment of a method for determining user intention based on voice.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Embodiments of the present disclosure will be described in relation to the accompanying drawings.

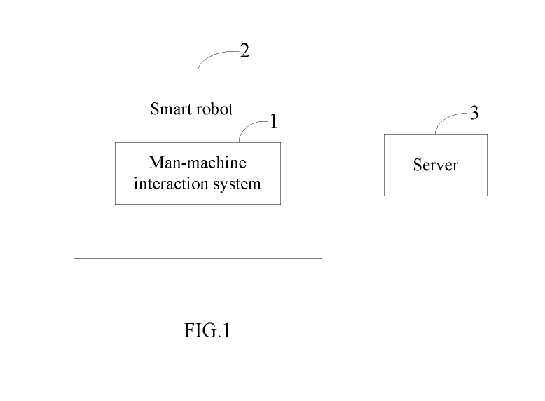

FIG. 1 illustrates a running environment of a man-machine interaction system 1. The man-machine interaction system 1 is run in a smart robot 2. The smart robot 2 communicates with a server 3 of a network. In at least one embodiment, the server 3 can be a cloud server. The man-machine interaction system 1 acquires user's voice and user's expression, generates a response including an animation of an expression according to the acquired user's voice and user's expression, and outputs the response to make the smart robot 2 interact with human.

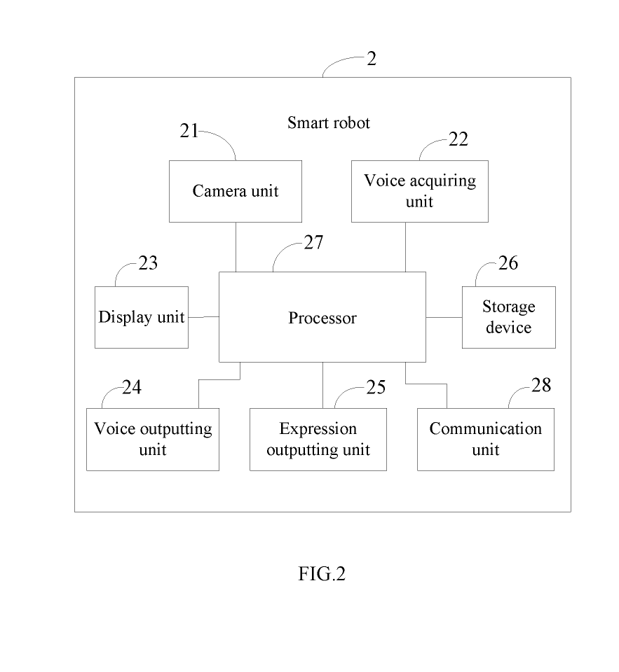

FIG. 2 illustrates the smart robot 2. In at least one embodiment, the smart robot 2 includes, but is not limited to, a camera unit 21, a voice acquiring unit 22, a display unit 23, a voice outputting unit 24, an expression outputting unit 25, a storage device 26, a processor 27, and a communication unit 28. The processor 27 connects to the camera unit 21, the voice acquiring unit 22, the display unit 23, the voice outputting unit 24, the expression outputting unit 25, the storage device 26, and the communication unit 28. The camera unit 21 acquires images around the smart robot 2 and transmits the images to the processor 27. In at least one embodiment, the camera unit 21 can be a camera or a 3D light field camera. The camera unit 21 captures image of a user's face around the smart robot 2 and transmits the image to the processor 27. The voice acquiring unit 22 acquires voice data/information speaking around the smart robot 2 and transmits the voice to the processor 27. In at least one embodiment, the voice acquiring unit 22 can be a single microphone or a microphone array. The display unit 23 displays data of the smart robot 2 under the control of the processor 27. In one embodiment, under the control of the processor 27, the display unit 23 displays animated images.

The voice outputting unit 24 outputs speech under control of the processor 27. In at least one embodiment, the voice outputting unit 24 can be a loudspeaker. The expression outputting unit 25 outputs expression under the control of the processor 27. In an embodiment, the expression can be a happiness, sadness, or other expression of user's mood. In at least one embodiment, the expression outputting unit 25 includes an eye and a mouth. The eye and the mouth can be opened or closed. The expression outputting unit 25 controls the eye or the mouth to open and close under the control of the processor 27. The smart robot 2 communicates with the server 3 through the communication unit 28. In at least one embodiment, the communication unit 28 can be a WIFI communication module, a ZIGBEE communication module, or a BLUETOOTH module.

The storage device 26 stores data and programs of the smart robot 2. In one embodiment, the storage device 26 can store the man-machine interaction system 1, preset face images, and preset voices. In at least one embodiment, the storage device 26 can include various types of non-transitory computer-readable storage mediums. In one embodiment, the storage device 26 can be an internal storage system of the smart robot 2, such as a flash memory, a random access memory (RAM) for temporary storage of information, and/or a read-only memory (ROM) for permanent storage of information. The storage device 26 can also be an external storage system, such as a hard disk, a storage card, or a data storage medium. In at least one embodiment, the processor 27 can be a central processing unit (CPU), a microprocessor, or other data processor chip that performs functions of man-machine interaction system 1.

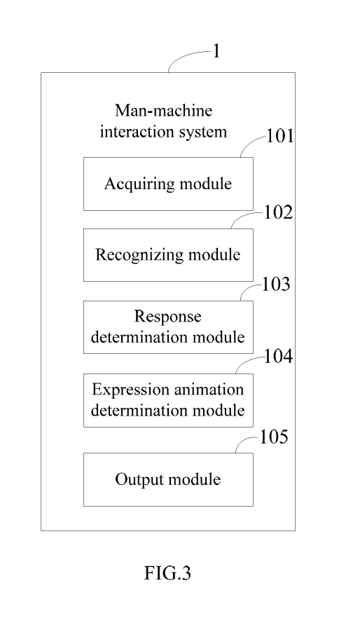

FIG. 3 illustrates the man-machine interaction system 1. In at least one embodiment, the man-machine interaction system 1 includes, but is not limited to, an acquiring module 101, a recognizing module 102, a response determination module 103, an expression animation determination module 104, and an output module 105. The modules 101-105 of the system 1 can be collections of software instructions. In at least one embodiment, the software instructions of the acquiring module 101, the recognizing module 102, the response determination module 103, the expression animation determination module 104, and the output module 105 are stored in the storage device 26 and executed by the processor 27.

The acquiring module 101 acquires voice data/information through the voice acquiring unit 22.

The recognizing module 102 recognizes words of voice acquired by the acquiring module 101 to determine user's emotional characteristic. In at least one embodiment, user's emotional characteristic can include happiness, anger, joy, despair, anxiety, and so on. In one embodiment, when the recognizing module 102 recognizes the voice as “It's Friday, let's go out and have a good time”, the recognizing module 102 determines the emotional characteristic corresponding to such words as happy. For another embodiment, when the recognizing module 102 recognizes the words as “bad weather today, we can't go out”, the recognizing module 102 determines the emotional characteristic corresponding to such words as despair. Determining user's emotional characteristic according to user's voice is well-known in prior art.

The recognizing module 102 determines user's intention according to words of user's voice. In one embodiment, when the recognizing module 102 recognizes “it's Friday, let's go out and have a good time”, the recognizing module 102 determines that user intends to hang out with his or her friends. In detail, the recognizing module 102 extracts a number of feature words from the voice. Each feature word corresponds to one level in a tree structure intention library. In one embodiment, the recognition module 102 inputs the voice into a feature character extraction model, and obtains the feature words corresponding to all levels of the feature character extraction model output by the preset feature character extraction model. In one embodiment, the preset feature character extraction model carries out semantic analysis on the words of the voice, and obtains feature words corresponding to all levels of the tree structure intention library. In at least one embodiment, all levels of the tree structure intention library correspond to one feature character extraction model. In at least one embodiment, when the voice is input into the feature character extraction model, the recognition module 102 obtains the feature words corresponding to all levels of the feature character extraction model. Then, the recognition module 102 regards the feature words corresponding to the first level of the feature character extraction model as the current feature words and regards all predictable intentions in the first level of the tree structure intention library as candidate intentions.

The recognition module 102 further matches the current feature words with each candidate intention to obtain a current intention. In one embodiment, the recognition module 102 regards the candidate intention matched with the current feature words as being the current intention. In at least one embodiment, the current intention includes all candidate intentions that have matched with the current feature words. Then, the recognition module 102 determines whether all feature words are matched with the candidate intention. When majority feature words are matched with the candidate intention, the recognition module 102 regards the current intention as the user's intention. When not majority feature words are matched with candidate intention, the recognition module 102 regards the feature words corresponding to next level of the feature character extraction model as the current feature words, and regards all intentions in the next level of the tree structure intention library as the candidate intention. The module 102 matches the current feature words with each candidate intention until majority feature words are matched with the candidate intention. Finally, when majority feature words are matched with the candidate intention, the recognition module 102 regards the current intention as the user's intention.

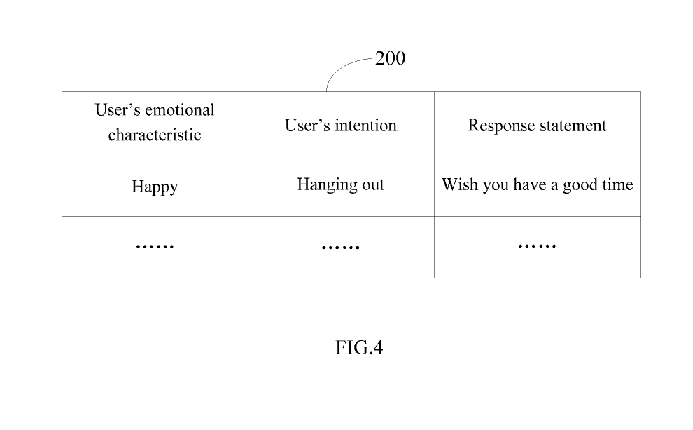

The response determination module 103 determines a response according to user's emotional characteristic, user's intention, and a response relationship table 200. FIG. 4 illustrates the response relationship table. The response relationship table 200 includes a number of user's emotional characteristics, a number of user's intentions, and a number of responses. A relationship is defined among the number of user's emotional characteristics, the number of user's intentions, and the number of responses. According to user's emotional characteristic and the user's intention as determined by the recognizing module, the response determination module 103 searches the response relationship table 200 to determine the response corresponding to user's emotional characteristic and user's intention. In the response relationship table 200, the response corresponding to user's emotional characteristic characterized as “happy” and user's intention characterized as “hanging out” is to express wish that user will have a good time. According to user's emotional characteristic characterized as “happy” and user's intention characterized as “hanging out”, the response determination module 103 searches the response relationship table 200 to determine upon the response as being “Have a good time!” In at least one embodiment, the response relationship table 200 is stored in the storage device 26. In another embodiment, the response relationship table 200 is stored in the server 3.

The output module 105 controls the voice outputting unit 24 to output the response.

In at least one embodiment, the acquiring module 101 further acquires the face image from the camera unit 21. The expression animation determination module 104 determines an expression animation of an animated image according to the acquired face image. In an embodiment, the expression animation determination module 104 analyzes facial expression from the acquired face image, extracts facial expression features of the facial expression to determine facial expression feature parameters, and determines the expression animation of the animated image according to the facial expression feature parameters. In at least one embodiment, the facial expression feature parameters includes head height, head circumference, eye width, eye height, eye-to-eye distance, nose width, nose length, mouth width, and so on. The animated image can be a small pig, a small dog, a small bear, or other cartoon image. In at least one embodiment, the expression animation determination module 104 processes the facial expression feature parameters by utilizing Face Action Coding System (FACS) to determine the expression animation of the animated image. The output module 105 controls the display unit 23 to display the expression animation of the animated image.

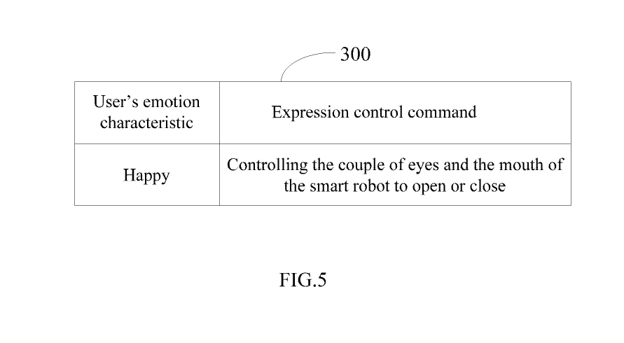

In at least one embodiment, the output module 105 further determines an expression control command according to user's emotion characteristic and an expression relationship table 300, and controls the expression outputting unit 25 to output an expression according to the expression control command. In at least one embodiment, the expression outputting unit 25 includes a couple of eyes and a mouth. The couple of eyes and the mouth can be opened or closed. FIG. 5 illustrates the expression relationship table 300. The expression relationship table 300 includes a number of user's emotion characteristics and a number of expression control commands, and defines a relationship between the number of emotion characteristics and the number of the expression control commands. After determining user's emotion characteristic, the output module 105 searches the expression relationship table 300 to determine which expression control command corresponds to user's emotion characteristic. In one embodiment, in the expression relationship table 300, the expression control command corresponding to a “happy” emotion characteristic is to control the couple of eyes and the mouth of the smart robot 2 to open or close. When the output module 105 determines that user's emotion characteristic is happy, the output module 105 controls the couple of eyes and the mouth of the smart robot 2 to open or close.

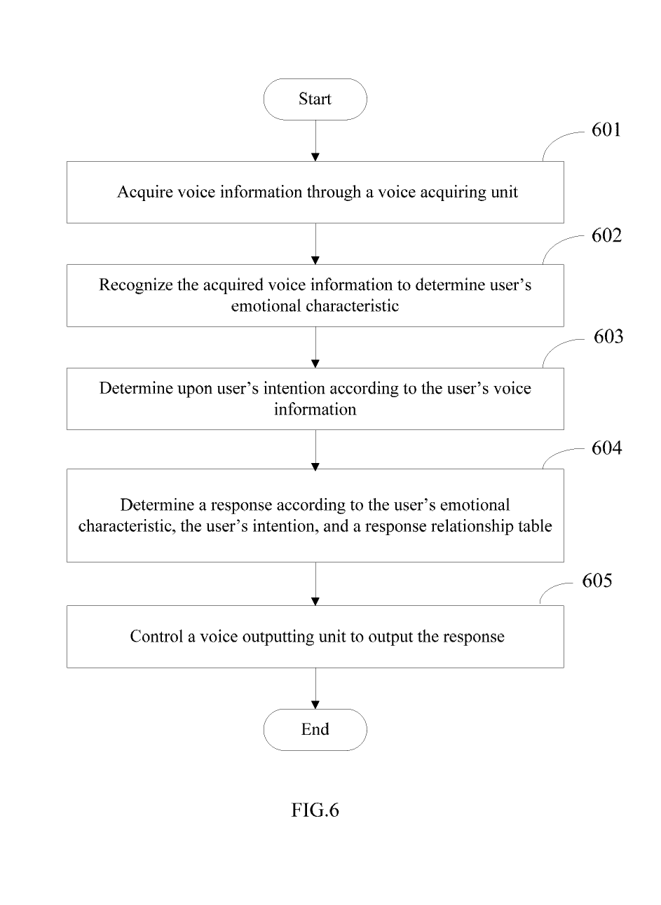

FIG. 6 illustrates a flowchart of one embodiment of a man-machine interaction method. The method is provided by way of example, as there are a variety of ways to carry out the method. The method described below can be carried out using the configurations illustrated in FIGS. 1-5, and various elements of these figures are referenced in explaining the method. Each block shown in FIG. 6 represents one or more processes, methods, or subroutines carried out in the method. Furthermore, the illustrated order of blocks is by only and the order of the blocks can be changed. Additional blocks may be added or fewer blocks may be utilized, without departing from this disclosure. The method can begin at block 601.

At block 601, a smart robot acquires voice information through a voice acquiring unit.

At block 602, the smart robot recognizes the acquired voice information to determine user's emotional characteristic.

In at least one embodiment, user's emotional characteristic includes happiness, anger, joy, despair, anxiety, and so on. In one embodiment, when recognizing the words “It's Friday, let's go out and have a good time” in the voice, the smart robot determines that the emotional characteristic corresponding to such words is happy. When recognizing “the weather is bad today, we can't go out”, the smart robot determines that the emotional characteristic corresponding to such words is sadness.

At block 603, the smart robot determines upon user's intention according to the user's voice information. In one embodiment, when recognizing “It's Friday, let's go out and have a good time”, the smart robot determines that user's intention is to hang out with friends.

At block 604, the smart robot determines a response according to the user's emotional characteristic, the user's intention, and a response relationship table. The response relationship table includes a number of user's emotional characteristics, a number of user's intentions, and a number of responses. A relationship is defined among the number of user's emotional characteristics, the number of user's intentions, and the number of responses.

According to user's emotional characteristic and user's intention as, the smart robot searches the response relationship table to determine upon the response corresponding to user's emotional characteristic and user's intention. In the response relationship table, the response corresponding to user's emotional characteristic of “happy” and user's intention characterized as “hanging out with friends” is to express wishes that user has a good time. According to user's emotional characteristic characterized as “happy” and user's intention characterized as “hanging out with friends”, the smart robot searches the response relationship table to determine upon a response of “have a good time!”.

At block 605, the smart robot controls a voice outputting unit to output the response.

In one embodiment, the method further includes the smart robot acquiring the face image from a camera unit, determining upon an expression animation of an animated image according to the acquired face image, and controlling a display unit to display the expression animation of the animated image.

In one embodiment, the smart robot analyzes facial expression from the acquired face image, extracts facial expression feature of the analyzed facial expression to determine facial expression feature parameters, and determines the expression animation of the animated image according to such parameters. In at least one embodiment, the facial expression feature parameters include head height, head circumference, eye width, eye height, distance between eyes, nose width, nose length, mouth width, and so on. The animated image can be a small pig, a small dog, a small bear, or other cartoon image. In one embodiment, the smart robot processes the facial expression feature parameters by utilizing Face Action Coding System (FACS) to determine upon the expression animation of the animated image.

In one embodiment, the method further includes the smart robot determining an expression control command according to user's emotion characteristic and an expression relationship table. An expression outputting unit is controlled to output an expression according to the expression control command. In at least one embodiment, the expression outputting unit includes a couple of eyes and a mouth. The couple of eyes and the mouth can be opened or closed. In one embodiment, the expression relationship table includes a number of user's emotion characteristics and a number of expression control commands, and defines a relationship between them. After determining user's emotion characteristic, the smart robot searches the expression relationship table to determine upon the expression control command corresponding to user's emotion characteristic. In one embodiment, in the expression relationship table, the expression control command corresponding to user's emotion characteristic of “happy” is controlling the couple of eyes and the mouth of the smart robot to open or close. When determining that user's emotion characteristic is happy, the smart robot controls the couple of eyes and the mouth of the smart robot to open or close.

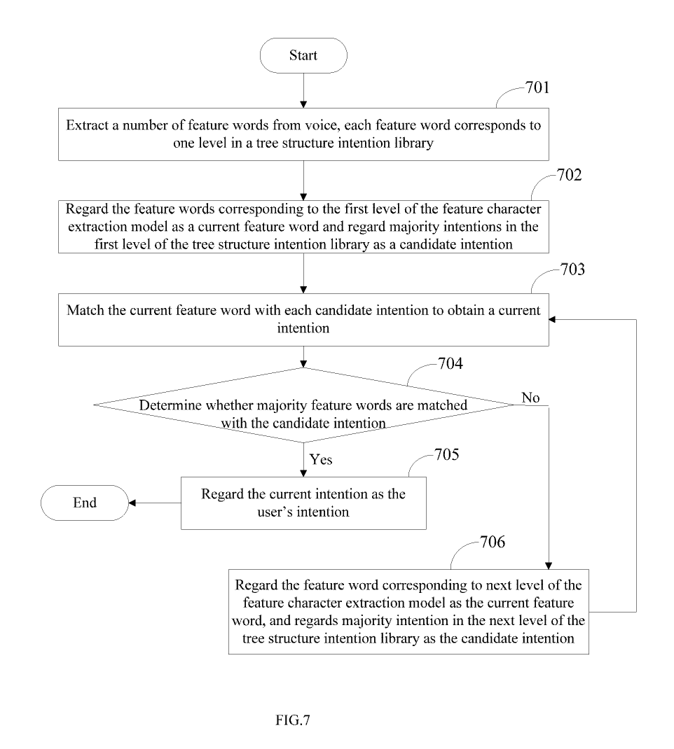

FIG. 7 illustrates a flowchart a method for determining user intention based on his or her voice. The method can begin at block 701.

At block 701, the smart robot extracts a number of feature words from the acquired voice. Each feature word corresponds to one level in a tree structure intention library.

In one embodiment, the smart robot inputs the acquired voice into a feature character extraction model, and obtains the feature words corresponding to majority levels of the feature character extraction model output by the preset feature character extraction model. In one embodiment, the preset feature character extraction model carries out semantic analysis on the words of the voice, and obtains feature words corresponding to majority levels of the tree structure intention library. In one embodiment, majority levels of the tree structure intention library correspond to one feature character extraction model. In one embodiment, when the voice is input into the feature character extraction model, the smart robot obtains the feature words corresponding to majority levels of the feature character extraction model.

At block 702, the smart robot regards the feature words corresponding to the first level of the feature character extraction model as the current feature words and regards majority intentions in the first level of the tree structure intention library as a candidate intention.

At block 703, the smart robot matches the current feature word with each candidate intention to obtain a current intention. In one embodiment, the smart robot regards the candidate intention matching with the current feature words as the current intention. In one embodiment, the current intention includes majority candidate intentions that have matched with the current feature words.

At block 704, the smart robot determines whether majority feature words are matched with the candidate intention. When majority feature words are matched with the candidate intention, the method executes block 705, otherwise the method executes block 706.

At block 705, the smart robot regards the current intention as the user's intention.

At block 706, the smart robot regards the feature word corresponding to next level of the feature character extraction model as the current feature word, and regards majority intentions in the next level of the tree structure intention library as the candidate intention. Then the method goes back to block 703. In one embodiment, when majority feature words are matched with the candidate intention, the smart robot regards the current intention as the user's intention.

The embodiments shown and described above are only s. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A smart robot comprising:
a voice acquiring unit configured to acquire voice information around the smart robot;
a voice outputting unit;
a processor coupled to the voice acquiring unit and the voice outputting unit; and
a non-transitory storage medium coupled to the processor and configured to store a plurality of instructions, the instructions can cause the smart robot to:
acquiring voice information by the voice acquiring unit;
recognizing the acquired voice information to determine a user's emotional characteristic;
determining a user's intention according to the voice information;
determining a response according to the user's emotional characteristic, the user's intention and a response relationship table defining a relationship among a plurality of user's emotional characteristics, a number of user's intentions and a plurality of responses; and
controlling the voice outputting unit to output the response.

2. The smart robot as recited in claim 1, wherein the smart robot further comprises a camera unit and a display unit, the plurality of instructions are further configured to cause the smart robot to:
acquiring a face image by the camera unit;
determining an expression animation of an animated image according to the acquired face image; and
controlling the display unit to display the expression animation of the animated image.

3. The smart robot as recited in claim 2, wherein the plurality of instructions are further configured to cause the smart robot to:
analyzing facial expression from the acquired face image;
extracting facial expression feature of the analyzed facial expression to determine facial expression feature parameters;
processing the facial expression feature parameters by utilizing Face Action Coding System to determine the expression animation of the animated image.

4. The smart robot as recited in claim 1, wherein the smart robot further comprises a expression outputting unit, the plurality of instructions are further configured to cause the smart robot to:
determining an expression control command according to user's emotion characteristic and an expression relationship table, wherein the expression relationship table comprises a plurality of user's emotion characteristics and a plurality of expression control commands, and defines a relationship between the plurality of emotion characteristics and the plurality of the expression control commands; and
controlling the expression outputting unit to output an expression according to the expression control command.

5. The smart robot as recited in claim 1, wherein the plurality of instructions are further configured to cause the smart robot to:
extracting a plurality of feature words from the voice information, wherein each feature word corresponds to one level in a tree structure intention library;
regarding one feature word corresponding to the first level of the feature character extraction model as a current feature word and regarding majority intentions in the first level of the tree structure intention library as a candidate intention;
matching the current feature word with each candidate intention to obtain a current intention;
determining whether majority feature words are matched with the candidate intention; and
regarding the current intention as the user's intention when majority feature words are matched with the candidate intention.

6. The smart robot as recited in claim 5, wherein the plurality of instructions are further configured to cause the smart robot to:
when not majority feature words are matched with the candidate intention,
regarding the feature word corresponding to next level of the feature character extraction model as the current feature word;
regarding majority intentions in the next level of the tree structure intention library as the candidate intention; and
matching the current feature word with each candidate intention until majority feature words are matched with the candidate intention.

7. A man-machine interaction method comprising:
acquiring voice information by a voice acquiring unit;
recognizing the acquired voice information to determine a user's emotional characteristic;
determining a user's intention according to the voice information;
determining a response according to the user's emotional characteristic, the user's intention and a response relationship table defining a relationship among a plurality of user's emotional characteristics, a plurality of user's intentions and a plurality of responses; and
controlling a voice outputting unit to output the response.

8. The method as recited in claim 7, further comprising:
acquiring a face image by a camera unit;
determining an expression animation of an animated image according to the acquired face image; and
control a display unit to display the expression animation of the animated image.

9. The method as recited in claim 8, further comprising:
analyzing facial expression from the acquired face image;
extracting facial expression feature of the analyzed facial expression to determine facial expression feature parameters;
processing the facial expression feature parameters by utilizing Face Action Coding System to determine the expression animation of the animated image.

10. The method as recited in claim 8, further comprising:
determining an expression control command according to user's emotion characteristic and an expression relationship table, wherein the expression relationship table comprises a plurality of user's emotion characteristics and a plurality of expression control commands, and defines a relationship between the plurality of emotion characteristics and the plurality of the expression control commands; and
controlling a expression outputting unit to output an expression according to the expression control command.

11. The method as recited in claim 7, further comprising:
extracting a plurality of feature words from the voice information, wherein each feature word corresponds to one level in a tree structure intention library;
regarding one the feature word corresponding to the first level of the feature character extraction model as a current feature word and regarding majority intentions in the first level of the tree structure intention library as a candidate intention;
matching the current feature word with each candidate intention to obtain a current intention;
determining whether majority feature words are matched with the candidate intention; and
regarding the current intention as the user's intention when majority feature words are matched with the candidate intention.

12. The method as recited in claim 11, further comprising:
when not majority feature words are matched with the candidate intention,
regarding the feature word corresponding to next level of the feature character extraction model as the current feature word;
regarding majority intentions in the next level of the tree structure intention library as the candidate intention; and
matching the current feature word with each candidate intention until majority feature words are matched with the candidate intention.
